(19) United States
(12) Patent Application Publication
(10) Pub. No.: US 2020/0160233 A1
(43) Pub. Date: May 21, 2020

(54) TAP TO RESERVE

(71) Applicant: VISA INTERNATIONAL SERVICE ASSOCIATION, San Francisco, CA (US)

(72) Inventor: Akshay Chopra, Singapore (SG)

(21) Appl. No.: 16/617,255

(22) PCT Filed: May 26, 2017
(86) PCT No.: PCT/US17/34755

§ 371 Date: Nov. 26, 2019

(51) Int. Cl. G06Q 10/02; G06Q 30/02

(52) U.S. Cl. CPC G06Q 10/02; G06Q 30/0201

(57) ABSTRACT

The described system and method allows a user to interact with a reservation sensor at the desired point and a separate analysis server to reserve a place for a good or service.

### BACKGROUND

Reserving a place such as a table or a bench or a spot in line has long been a challenge. On one hand, there is a desire to venture away from the place to get food or drinks, chat with friends, examine options, or just get some exercise. But at the same time, the place being held requires a physical indication that it is being reserved. In the past, people have left keys or purses, tissues or other personal items to indicate that a place is taken. However, these personal items may be easily stolen or brushed aside.

### SUMMARY

The described system and method allows a user to interact with a reservation sensor at the desired point and a separate analysis server to reserve a place for a good or service. The user may communicate an identification signal to the reservation sensor which may be on a table or at another desirable location. The reservation sensor may communication the identification signal to the analysis server to determine if the user is known. In response to the user being known, the system may determine a current rating for the user. If the rating is over a threshold, a signal may be communicated to the reservation sensor to indicate that the desired point is reserved for a period of time. If the rating is under a threshold, a signal may be communicated to the reservation sensor that a reservation is not currently available. In some embodiments, the threshold may change based on the time of day, the amount of demand and the expected volume of people.

### BRIEF DESCRIPTION OF THE DRAWINGS

FIG. 1 may be an illustration of a sample computer system;

FIG. 2 may be a flowchart of the blocks of executed by the computer system;

FIG. 3 may be a sample computer system including a token server

FIG. 4 may be an illustration of the computing elements that are part of the reservation sensor;

FIG. 5 may be an illustration of the input and output components of the reservation sensor;

FIGS. 6a and 6b may be sample reservation servers with lights;

FIG. 7 may be a sample reservation server with an image sensor; and

FIG. 8 may be a sample user interface to monitor the system.

### DESCRIPTION

Reserving a place such as a table or a bench or a spot in line has long been a challenge. On one hand, there is a desire to venture away from the place to get food or drinks, chat with friends, examine options, or just get some exercise. But at the same time, the place need a physical indication that it is being reserved. In the past, people have left keys or purses or packs of tissue or other personal items to indicate that a place is taken. However, these personal items may be easily stolen or brushed aside. Sometimes, the concept of reserving a spot is known as to chope or choping.

The described system and method allows a user to interact with a reservation sensor at the desired point and a separate analysis server to reserve a place. The user may communicate an identification signal to the reservation sensor which may be on a table or at another desirable location. The reservation sensor may communication the identification signal to the analysis server to determine if the user is known. In response to the user being known, the system may determine a current rating for the user. If the rating is over a threshold, a signal or decision 225 may be communicated to the reservation sensor 215 to indicate that the desired point is reserved for a period of time. If the rating is under a threshold, a signal such as a decision 225 may be communicated to the reservation sensor 215 that a reservation is not currently available. In some embodiments, the threshold may change based on the time of day, the amount of demand and the expected volume of people.

One of the many technical problems addressed by the system 50 and method is how to build an easy to use system to reserve places that tracks time and sifts users from abusing the system 50 but provides security to users. In addition, physical products need to be designed and built to allow notice to be given to others that a table or spot has been reserved where the physical product may be installed in a permanent manner at a location that is desired to be reserved.

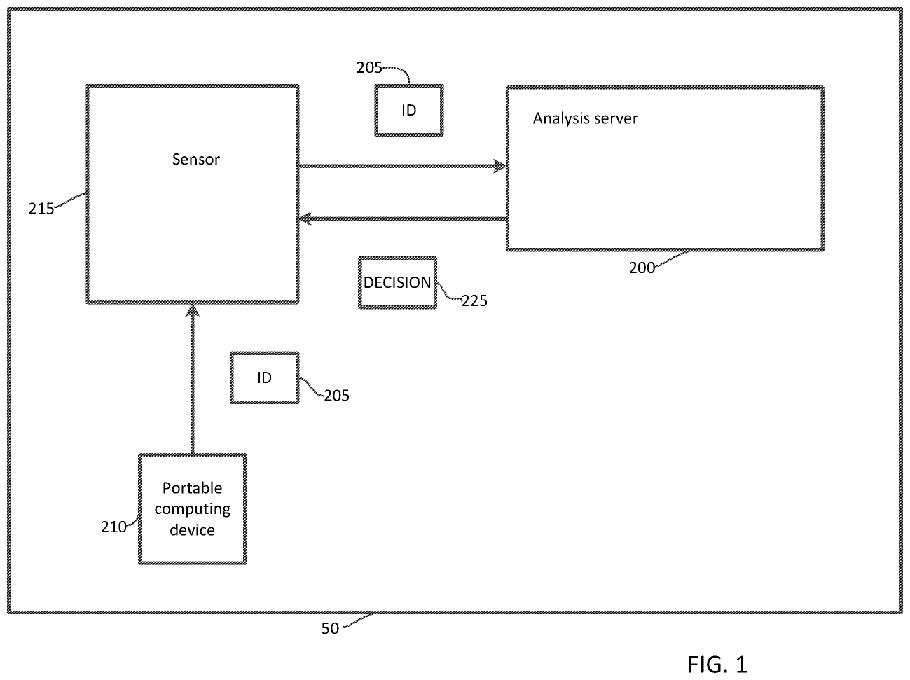

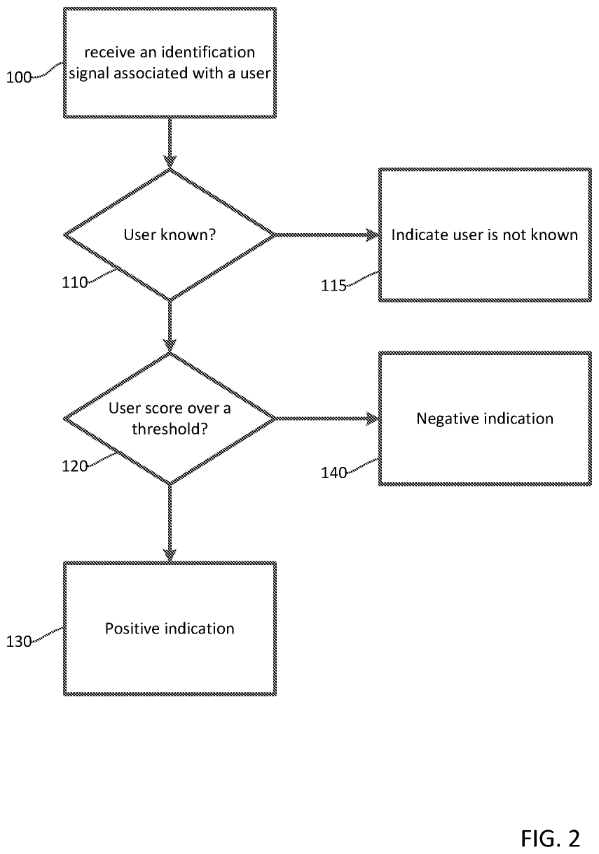

FIG. 1 may illustrate an embodiment of a system 50 for reservations and FIG. 2 may be a flowchart of computer blocks that may be executed by the system 50 for reserving a good or service. At block 100, an analysis server 200 may receive an identification signal 205 associated with a user from a reservation sensor 215.

The reservation sensor 215 may receive data that may be used to identify a user and may provide notice to others that a good or service has been reserved or is use. The reservation server may have a variety of computing elements such as a processor, a memory, an input/output circuit and a variety of input devices and output devices. As will be explained further, the input to the reservation sensor may take on a variety of forms depending on the form of the reservation sensor 215, the environment and the technology available to the user and the provider of goods and services. As a brief example, if the reservation sensor 215 has an image sensor, the input may be an image of a face, a fingerprint or an iris while in other embodiments, the reservation sensor 215 may simply communicate received signals from additional computing devices of the user to the analysis server 200.

The analysis server 200 may be physically configured according to computer executable instructions to make decisions and execute analysis regarding whether a reservation may be made for a given user. The analysis server 200 may contain an analysis processor, an analysis memory, an analysis input output circuit and an analysis power source. The analysis server 200 may be physically configured to speed decision making and handle a significant rush of requests during periods of heavy use. Logically, it may have a large memory buffer to ensure requests for decisions are not lost or denied during peak times.

The identification signal 205 may be used to identify the user that is requesting the reservation. The identification signal make take on a variety of forms. In some embodiments, the identification signal is pushed from the portable computing device 210 to the reservation sensor 215 such as on a periodic basis or when a location sensor such as a GPS signal informs the portable computing device 210 that a known reservation sensor is nearby. In such a situation, the identification signal 205 may be a data packet in a variety of forms assuming the reservation sensor and analysis server 200 can parse the data packet. Logically, the identification signal 205 may use encryption to protect the identification signal 205 from being stolen.

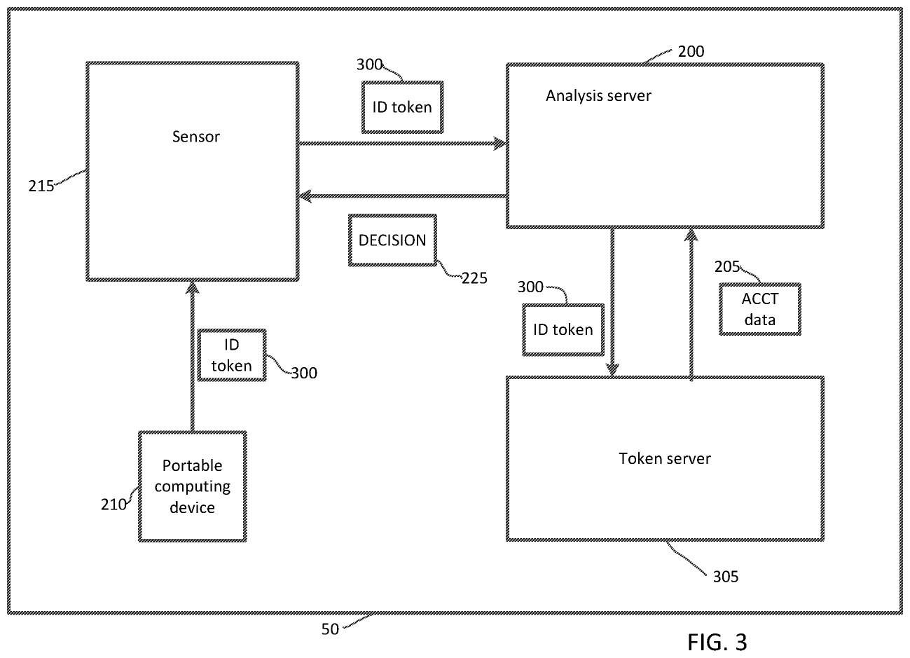

In some embodiments, the identification signal 205 may be in the form of a token as illustrated in FIG. 3. The portable electronic device 210 may have an application as part of the reservation system 50 and the application may be in communication with a token server. The token may be a known code that represents the actual identification signal. The token server may receive the token and translate the token into the actual identification data. In such a situation, if the token is stolen, the data will be worthless as only the token server knows the identification data to which the token is related.

In other embodiments, the identification signal 205 may be pulled from the portable computing device 210 such as when a welcome signal is received from the reservation sensor 215, In some embodiments, the portable electronic device 210 may be passive and may be activated from an NFC signal from the reservation sensor. The NFC signal may charge a capacitor or battery in the portable electronic device and the portable electronic device which may then communicate an identification signal once a sufficient charge has been received. In other pull embodiments, the identification signal 205 may be communicated once a welcome signal is received from the reservation sensor or another indication is received that a reservation sensor is available for communication.

The portable electronic device 210 may be used as part of the system 50 as a host of an application. The application may be used to assist in orchestrating the system 50. For example, the application may coordinate communications with the reservation sensor, may assist in encryption or token creation, may assist with tracking whether a reservation has been granted, how the reservation may last, if there is a waiting list for a reservation, where the user is on the waiting list, etc. In addition, in embodiments where tokens are used, the application may be used to generate tokens and may be used to interface with the token server to properly track the tokens.

The application also may be used to indicate the current user rating to the user. In some embodiments, the user may be able to take steps to improve a rating in a particular situation. For example, in some embodiments, the user may be able to pay a fee to increase a rating such that a reservation will be more likely. In other embodiments, the user may be able to increase a rating by taking other steps such as filling out a survey, watching an advertisement or registering with a specific rewards program.

Notifications to the user may be set up through the app. For example, if the user desires to receive text messages about a reservation, a user may create the desired communication format in the app. Similarly, if the user would like several people notified, the user may be able to add those people to be notified. In yet another example, if the user does not desire notifications, the app may be used to eliminate second channel notifications.

In other embodiments, the portable computing device 210 may have less capabilities. For example, a ring may be physically small and may have a smaller processor that has limited capabilities. For example, in some embodiments, the portable computing device 210 may be have a display and the entire transaction may have to occur using other displays such as the display in the reservation sensor or without a display at all. The ring may have an NFC receiver, may be charged when in the vicinity of an NFC transmitter such as a reservation sensor and may respond with an identification signal once the device is sufficiently charged. In other embodiments, the portable computing device 210 may have some limited computing capabilities such as the ability to display limited information, may be able to provide haptic feedback or may be able to make some sounds, all of which may be useful as part of the reservation system 50.

The communication between the portable computing device 210 and the reservation sensor 215 may follow a defined protocol. For example, the first 64 bits of a communication from the app on the portable computing device 210 may be used to establish that the app is registered and is appropriate to communicate with the reservation sensor 215. The next 64 bits may contain identification data such as a Personal Account Number (PAN), which may be encrypted, or a MAC address of the portable computing device, or an indication that a verification image such as a bar code, QR code or other image from a verification spot near a reservation sensor, will follow in later blocks of bits. The next 64 bits may be used for error correction. The reservation sensor 215, the analysis server 200 and app may use the same structured format or protocol to communicate the necessary data to ensure efficient and accurate communication between the various elements of the system 50.

Logically, the form of the portable computing device 210 may take many forms. In some embodiments, a traditional smart phone may be used. In other embodiments, small form factor devices such as bracelets, rings, necklaces, glasses, fillings, earrings, clothing pins, processors sewn into fabrics, etc. may be used so long as the portable computing device is capable of providing an identification signal.

In other embodiments such as when a user does not have a computing device 210 capable of running an app or the user simply does not have the app, communications may be to an additional device such as a text message to a phone, a watch, a bracelet, a ring or a laptop. A limited capability device may be used to provide an identification signal to the analysis server and the addition messages that may be needed may be communicated using a second channel such as SMS messages, emails, social media notifications, etc.

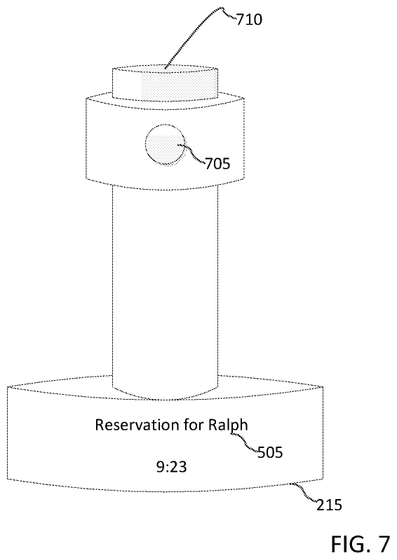

In yet another embodiment as illustrated in FIG. 7, the identification signal may be generated by the reservation sensor 215 using biometric inputs. As an example, the reservation system 50 may have an image sensor 705 and the captured image such as of a face, of a fingerprint, of a retina, back of a hand, etc., may be as an identification signal if the user has previously registered the biometric input as a registration data. The reservation sensor 215 may also have a dedicated fingerprint reader 710 which a user may only need to tap to start the reservation process.

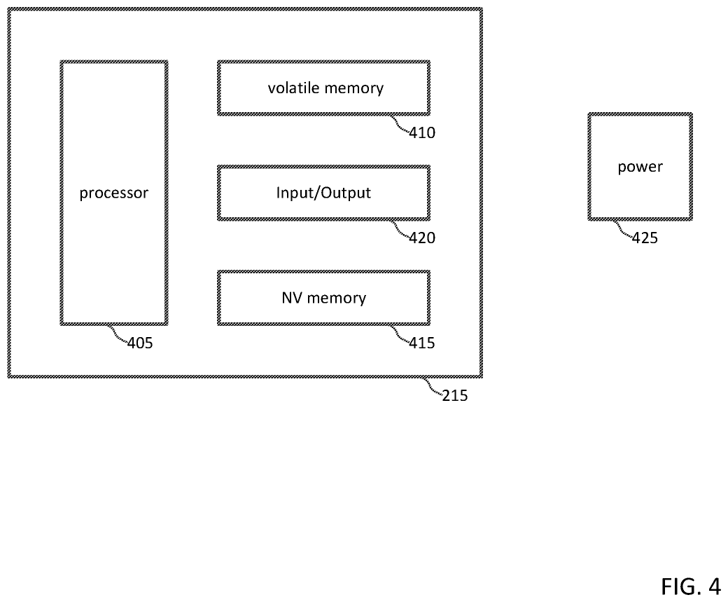

The reservation sensor 215 may take on a variety forms as long as the reservation sensor 215 can still perform the necessary functions required by the particular embodiment of the system 50. As illustrate in FIG. 4, in one embodiment, the reservation sensor 215 may include a reservation processor 405, a reservation memory 410, a reservation non-volatile memory 415, an input output circuit 420 and a power source 425. The processor 405 may be specifically designed and built for the reservation sensor 215 functions. Further, in some embodiments, the reservation sensor 215 may operate on a battery or other power source which may be drained and the processor may be designed in a way to conserve power. For example, the processor 405 may only operate the communication functions of the processor 405 when a customer or potential user is within range. Similarly, the countdown functions of the processor 405 may only operate when a customer or user is known to be within range.

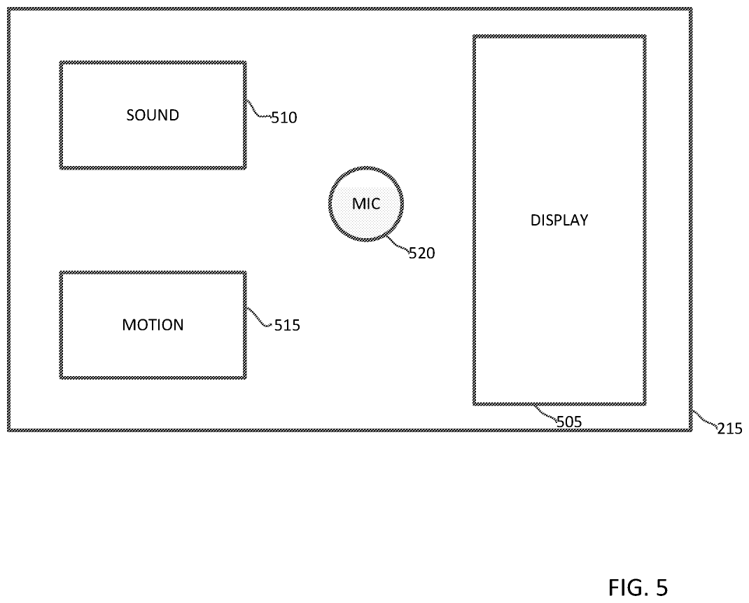

The reservation sensor 215 also may have a variety of ways of communicating to the user or those near the sensor. As illustrated in FIG. 5, the reservation sensor 215 may have a computer controlled display 505 which may be in a variety of shapes and sizes depending on the shape of the reservation sensor 215. In some situations, the display 505 may be adapted to the shape of the reservation sensor 215 such as being round, curved or flat. The display 505 may be quite simple and may only display a color such as green or red. The display 505 may be quite complex and may display text, numbers, images or moving images. In some embodiments, the display 505 may be touch sensitive and may accept inputs such as fingerprints or a textual/numeric input like a personal identification number (PIN), a query such as where a user is in a queue or other input.

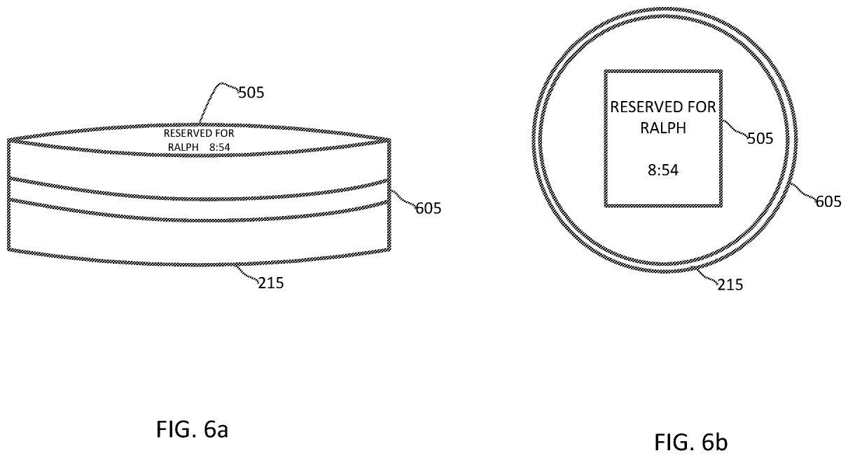

In other embodiments such as in FIG. 6a or 6b, a separate light 605 or ring of lights may be used to indicate a status such as that a good or service is reserved, may be reserved, that a reservation is complete, that a reservation request has been accepted, that a reservation request has been denied or that a reservation request is pending or has been added to the queue. The light may communicate the status in variety of ways that may be perceived by users such as a color, a flashing pattern, a specific set of lights being on and a specific set being off, etc. The lights may be configured by a user using the app or other portal into the system 50. For example, the user may configure the system 50 to display a specific color when a reservation has been successful and a separate color when a reservation was not successful. In other embodiments, the provider of the good or service may be able to configure the feedback to be location specific.

The reservation sensor 215 may also have a speaker 510 which may provide sounds to a user. The sounds may be spoken words or may be sounds associated with a successful reservation, a failed reservation, a pending reservation or a countdown. The sounds also may be configured by a user using the app or other portal into the system 50. For example, the user may configure the system 50 to play a specific song when a reservation has been successful and a separate song when a reservation was not successful. In other embodiments, the provider of the good or service may be able to configure the feedback to be location specific.

The reservation sensor 215 may also have a motion creation device 515. In one embodiment, an uneven weight on a motor may cause the reservation sensor to shake when it is activated. The motion also may be configured by a user using the app or other portal into the system 50. For example, the user may configure the system 50 to have a specific motion when a reservation has been successful and a separate motion when a reservation was not successful. In other embodiments, the provider of the good or service may be able to configure the feedback to be location specific.

The reservation sensor 215 also may have a microphone 520 as part of the system 50. The microphone may be used to verify a voice of a user. In yet another embodiment, the microphone may be used to accept voice commands from a user. Common commands such as “make reservation”, “my name is ralph”, “where am I in the queue”, “my id number is XOF45678”, etc, may be accepted and communicated to the analysis server 200. In addition, the location of the goods or services may be able to configure the system 50 to accept voice inputs and provide responses such as “what are the specials?” or “are there any canoes due back shortly?”

Referring again to FIG. 1, at block 110, in some embodiments, it may be determined if the identification signal 205 associated with the user is eligible to be used by the analysis server 200. As a threshold, the system 50 may need to determine if the user is known by the system 50. For example, in some situations such as at a small restaurant, only invited users may be able to make a reservation for a table. Rather than have users become frustrated by the lack of response from the reservation sensor, the user may be informed immediately that the restaurant currently has a restrictive policy for reservations. In other situations, users that have abused the reservation system 50 may be promptly recognized and the system 50 may not be available for that user. As yet another example, the user may already have one table under reservation and the restaurant may only allow one restaurant at a time. If the user is not known, at block 115, feedback may be provided that the user is not knows. As will be described, the feedback may be visual, aura or through sensations.

In other embodiments, block 110 may be folded into blocks 130 or 140. Assuming the process is faster enough, a user may be informed whether the reservation request was successful or not successful and part of the communication may include that the user is not known or that the user is not entitled to use the system 50 at the present time.

If the user is not known, at block 115, feedback may be provided that the user is not knows. As will be described, the feedback may be visual, aura or through sensations. At block 120, in response to the identification signal 205 associated with the user being known by the analysis server 200, a user score may be analyzed. The user score may represent a ranking for the user in the reservation system 50. For example, if the user uses the system 50 often, tips well and does not abuse the system 50, the user may have a high ranking. On the opposite extreme, if the user rarely uses the system 50, gives poor tips and abuses the system 50, the user score may be low. The score may be specific to a merchant, to a location, to a type of restaurant, to a type of location or a combination of all of the individual scores.

The user score may be compared to a threshold to determine if the reservation request may be granted. The threshold may be specific to a merchant, to a location, to a type of restaurant, to a type of location or a combination of all of the individual threshold.

In some embodiments, the threshold may simply be that the table or desired good or service is available without regard as to who is making the request or whether the good or service is busy. The idea may be that the first person to request an available good or service may receive the good or service first. Logically, if a good or service is not currently reserved, then the reservation may be granted.

In some additional embodiments, the threshold may be dynamic. For example, if a restaurant is busy on Friday evenings, the restaurant may raise the threshold to successfully receive a reservation such that only the best customers with the highest ratings will receive a reservation. Similarly, threshold may be lowered when the restaurant is not busy.

The threshold may be set according to an algorithm. The algorithm may take into account a plurality of factors in setting the threshold. In some embodiments, the current demand may be determined. The current demand may be determined by polling the reservation sensors and determining how many are currently active with users requesting reservation of using the good or service. In some embodiments, the reservation may report back to the analysis server and the analysis server may be able to provide an estimate of the demand for a good or service. In another embodiment, the system 50 may use a queue and the number of users in the queue may provide an indication of how much demand is in place for the desired good or service. In other embodiments, a camera may be used to estimate the level of demand for the good or service. In yet another embodiment, a sound sensor may be used to estimate the demand for the good or service. Logically, determining the demand for a good or service by humans may be determined in one or more ways and many ways may be appropriate depending on the good or service in question. Logically, the threshold may be adjusted based on current demand to create an adjusted threshold. More specifically, if the demand is high, the threshold may be increased and if demand is low, the threshold may be reduced or eliminated altogether.

Similarly, the score of a user may be adjusted according to an algorithm, In one embodiment, a starting point may be a past scores of the user. If the user has been using the system 50 in an increasing fashion recently, the score may be adjusted up. If the user has not been using the system 50 recently, the system 50 may be reduced. Other factors that may be analyzed by the system 50 include the amount of money spent by the user on average when using the system 50, the average tip left by the user, the average time the user spent using a good or service, the number of people on average in the party of the user, etc. As mentioned previously, the user score may be for all goods or services or may be for a specific good or service or even a specific provider of the good or service.

In some additional embodiments, the user score or threshold may be adjusted as an incentive for the user to select a particular good or service. As an example, the new user may be granted a high score to ensure a positive reservation if the new user will agree to use a particular good provider or a particular service provider. The offer may be communicate via the reservation sensor or in a second channel such as through an email, an SMS message or a social media message to the user.

In yet a further embodiment, the threshold may be adjusted by using a learning algorithm. The learning algorithm may review past threshold levels in comparison to past sales and the threshold may be adjusted to maximize sales. Logically, the learning algorithm may also be adjusted to maximize profits or other desirable characteristics. As an example, past thresholds and past sales amounts may be broken into four groups. Three of the groups may be used to train the algorithm and the fourth group may be used to test the trained algorithm. Then, the groups may rotate where each group may have a turn as the test group.

Similarly, the user score may be adjusted by using a learning algorithm. The learning algorithm may review past user scored in comparison to past sales and the user score may be adjusted to maximize sales. Logically, the learning algorithm may also be adjusted to maximize profits or other desirable characteristics. As an example, past user scores and past sales amounts may be broken into four groups. Three of the groups may be used to train the algorithm and the fourth group may be used to test the trained algorithm. Then, the groups may rotate where each group may have a turn as the test group.

In additional embodiments, a queue may form of requesting users. For example, at a busy restaurant on a Friday night, a queue may be formed and tracked by the analysis server 100. Users in the queue may be informed of their place in the queue along with their expected wait time and when the wait is over. For example, the user may request a table for four and the system 50 may estimate when the next table for four will be available and the estimate may be provided to the user. In addition, the estimate may be updates as people leave or arrive at the restaurant. The queue may be a pure, first come/first server type queue of the queue may take into account the user rating to determine if a waiting scheme should be used to manage the queue. For example, a valuable customer may have a large user rating and the valuable customer may jump to the head of the queue based on a user rating based weight which may be created using an algorithm.

At block 130, in response to the reservation score being determined to be above the threshold, a positive indication 225 on the reservation sensor 215 that the point of service for the good or service has been reserved may be provided. The positive indication may take on a variety of forms which may depend on the form and features of the reservation sensor 215 as mentioned previously. In some embodiments, the reservation sensor may have a display 215 and the display 215 may inform the user that the reservation request was successful.

In some additional embodiments, the reservation sensor 215 may not have a display 505 but a success message may be communicated over an additional channel. As an example, a text message or email may be communicated to the user that the reservation request was successful. In yet another embodiment, a message may be communicate to the user via a social media platform. In this way, others that may be part of the party waiting on the reservation may also be informed that the reservation has been approved. In yet another embodiment, an app associated with the system 50 may receive a message that the reservation request has been accepted.

In other embodiments, the reservation sensor 215 may have lights such as in FIGS. 6a and 6b that indicate that a reservation has been successfully made. For example, a green light may indicate that a reservation was successfully made. In another embodiment, a flashing light may indicate that a reservation was successfully made. In yet another embodiment, a light that flashes faster may indicate that a reservation has been successfully made. In yet another embodiment, the reservation sensor may have a speaker and a success message may be communicated such as a tone, a series of tones or a spoken message. In yet a further embodiment, the reservation sensor 215 may have the ability to move or shake or otherwise offer tactile feedback through a spinning counterweight, for example, that the reservation has been accepted. The various feedback mechanisms may work together, may be user configurable or may be configurable by the specific provider of goods and service.

In some embodiments, a count-down timer may displayed on the display 505 such that a good or service may not be reserved indefinitely. Further, those waiting for a good or service may understand how much time is left on a reservation. By displaying the time left, others may be better able to govern their behavior such as whether to wait, whether to find another good or service, etc.

In addition, in some embodiments, the reservation sensor 215 may communicate with the analysis server 200 the amount of time left on a reservation or if the good or service is currently in use. For example, the reservation sensor 215 may have an image device or a sound sensing device which may be used to determine if a good or service is currently in use.

At block 140 in response to the reservation score being below the threshold, a negative indication may be provided on the reservation sensor 215 that a reservation is not available at the present time. As with the positive indication, the notification may take on a variety of forms. In one embodiment, a light 605 (FIGS. 6a and 6b) on the reservation sensor may indicate that the reservation request was not accepted. In another embodiment, a message may be communicated to the user in a variety of ways such as via email, via sms message, via social media, etc. In some embodiments, the reservation sensor 215 may have a display 505 and the denial may be displayed on the reservation sensor 215. Similarly, the reservation sensor 215 may have a motion creating device and a motion may indicate that the reservation request was denied. The various feedback mechanisms may work together, may be user configurable or may be configurable by the specific provider of goods and service.

In some embodiments, the reservation request may not be immediately granted but the user may be placed in a queue. A separate indication may be communicated to the user if a queue is in use and the user had qualified to be in the queue. In one embodiment, the reservation sensor 215 may have a display 505 and the place in the queue and the projected wait may be illustrated on the display. In another embodiment, the place in the queue may be communicated to the user using an additional channel such as an SMS message, an email, a social media posting, etc.

The hardware of the system 50 may be physically configured to execute the functions of the system 50. The reservation sensor 215 may include a reservation processor that may be physically configured according to computer executable instructions. The instructions may include instructions for receiving identification signals 205 representative of a user, communicating the identification signals 205 representative of the user to the analysis server 200 for approval of a reservation request and receiving the reservation approval or denial indication from the analysis server 200. In response to the reservation being approved, executing at least one of displaying an indication 225 that the good or service is reserved, displaying a name of the user, displaying a timer that indicates how long the good or service is reserved, communicating an acceptance message to the portable computing device 210 of the user, communicating a timer to the portable computing device 210 of the user, creating a sound to indicate that the good or service has been reserved and/or creating a motion that indicate that the good or service has been reserved.

The analysis server 200 may include an analysis processor, an analysis memory, an analysis input output circuit and an analysis power source where the analysis processor may be physically configured according to computer executable instructions. The instructions may include determining if the identification signal 205 associated with the user received from the reservation sensor 215 is known by the analysis server 200. In response to the identification signal 205 associate with the user being known by the analysis server 200, the analysis server may determine if the user has a reservation score over a threshold and communicate the determination from the analysis server 200 to the reservations sensor 215.

In some embodiments such in illustrated in FIG. 3, the system 50 may include a token server 305. The token server 305 may include a token processor, a token memory, an token input output circuit and a token power source where the token processor may be physically configured according to computer executable instructions. The instructions may include receiving from the reservation sensor 215 a token 300 indicative of a user, analyzing the token 300 to match the token with a user identification data and communicating the user identification to the analysis server 200.

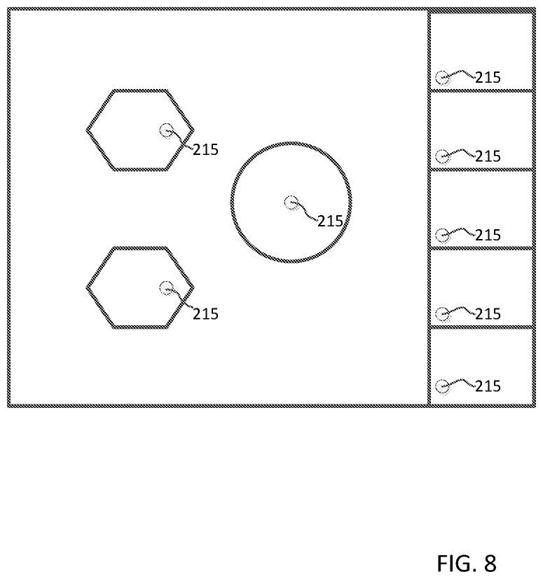

A user interface may be used as part of the system 50 and may be illustrated in FIG. 8. The illustration may have images of the various things in a space that may have a reservation sensor 215 and may be reserved. FIG. 8 is of a restaurant and each table or booth has a reservation sensor 215. Depending on the sophistication of the system 50, it may be able to determine the number of reservation requests and the projected queue length and related wait time based on the reservation request data. Further, the threshold may be adjusted based on the number of requests and current reservations pending. Finally, management may be able to view the representation and may be able to manually make adjustments to the thresholds or to make projections.

In some embodiments, users may also be able to remotely log into the system 50 and view the reservation data on a user interface such as through the app that may be part of the system 50. In this way, a user may know in advance whether a certain good or service is already fully reserved with a queue of other users. For example, if a restaurant is full and there is a queue of users, the estimated wait time for a reservation may be displayed. In some embodiments, users may be able to request a reservation or an entrance into the queue using the app or website on computing device. Similarly, a table in a kitchen in a restaurant with a famous chef may be very desirable and that reservation time for that specific table may be displayed along with the wait time for tables that are less desirable. Logically, the app may be user configurable or may be configurable by the provider of the goods or services in question.

In some versions of the app, there may be interactive features. For example, if the proper permissions are obtained, an app user may be able to communication with people at a given table through the reservation sensor 215. As an example, a user at home may be able to ask a restaurant customer “how is the food?”, “is parking available?” or “is anyone famous at the restaurant that evening?” The user may even be able to rotate the image capture device 705 on the reservation sensor 215 to obtain a view of the space. Logically, a user of the reservation system 50 may be able to select an option for their privacy to be respected and in such a case, the app would not be able to make remote contact with the user. Again, the remote capabilities of the app may only be limited by the imagination and by respecting the wishes of others in the space that desire privacy.

In another aspect of the invention, in some embodiments, the data from the user to the reservation sensor 215 may be sufficient to be used for payments at certain vendors. For example, the communication from the app to the reservation sensor 215 and analysis server 200 may contain a PAN and the other information that may be used to make a payment. The reservation sensor 215 may use the display, the fingerprint reader or the image sensor to verify and process the purchase. For example, in some embodiments, a user may be able to pay to secure a faster reservation and the payment may be made through the app. In another aspect, the payment for a meal may be made through the app, the reservation sensor 215 and the analysis server 200 which may communicate with the payment network (not shown).

The figures depict preferred embodiments for purposes of illustration only. One skilled in the art will readily recognize from the following discussion that alternative embodiments of the structures and methods illustrated herein may be employed without departing from the principles described herein.

The computing structures are described as being separate, purpose built device. In some embodiments, the computing structures may be combined into a single structure. In some situations, a computing structure may have a first processor for reservation control and s second processor for analysis control. In some embodiments, the same processor may be used for the entire system.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer system comprising:
a reservation sensor comprising a reservation processor, a reservation memory, an reservation input output circuit and a reservation power source wherein the reservation processor is physically configured according to computer executable instructions for:
receiving an identification signal associated with a user at a point of service for a good or a service along with a reservation request;
communicating the identification signal associated with the user to an analysis server;
in response to a reservation score being above a threshold,
providing an positive indication on the reservation sensor that the point of service for the good or service has been reserved;
in response to the reservation score being below the threshold, and
providing a negative indication on the reservation sensor that a reservation is not available currently;
the analysis server comprising an analysis processor, an analysis memory, an analysis input output circuit and an analysis power source wherein the analysis processor is physically configured according to computer executable instructions for:
determining if the user has a reservation score over a threshold; and
communicating the determination from the analysis server to the reservations sensor.

2. The computer system of claim 1, further comprising:
a token server comprising a token server comprising a token processor, a token memory, an token input output circuit and a token power source wherein the token processor is physically configured according to computer executable instructions for:
receiving from the reservation sensor a token indicative of a user;
analyzing the token to match the token with a user identification data; and
communicating the user identification data to the analysis server.

3. The computer system of claim 1, further comprising displaying on the reservation sensor at least one of:
a countdown timer indicating the time left on the reservation;
an indication that the user is not recognized;
an indication that a reservation is not currently available for the user; and
an indication of a ranking of the user in the system.

4. The computer system of claim 1, wherein a threshold scoring method comprises:
determining current demand;
adjusting threshold based on current demand to create an adjusted threshold;
analyzing past scores of the user to create an updated score;
comparing the updated score to adjusted threshold; and
classifying the updated score in view of the adjusted threshold.

5. The computer system of claim 4, wherein the adjusted threshold is determined using a learning algorithm to:
review past threshold adjustments;
review past sales;
determine the optimal threshold adjustment to maximize sales; and
setting the adjusted threshold according to the determined optimal threshold adjustment.

6. The computer system of claim 1, wherein the reservation sensor further comprises a processor physically configured for:
receiving identification signals representative of a user;
communicating the identification signals representative of the user to the analysis server for approval of a reservation request;
receiving the reservation approval or denial indication from the analysis server;
in response to the reservation being approved, executing at least one of:
displaying an indication that a good or a service is reserved;
displaying a name of the user;
displaying a timer that indicates how long the good or service is reserved;
communicating an acceptance message to a portable computing device of the user;
communicating a timer to the portable computing device of the user;
creating a sound to indicate that the good or service has been reserved; and
creating a motion that indicate that the good or service has been reserved.

7. A computer executable method for reserving a good or service using a reservation system comprising:
receiving at an analysis server an identification signal associated with a user from a reservation sensor at a point of service for the good or service along with a reservation request;
determining by the analysis server if the identification signal associated with the user is eligible to use the reservation system;
in response to the identification signal associated with the user being determined to be eligible by the analysis server,
determining if the user has a reservation score over a threshold;
in response to the reservation score being above the threshold,
providing an positive indication on the reservation sensor that the point of service for the good or service has been reserved and a reservation has been granted; and
in response to the reservation score being below the threshold,
providing a negative indication on the reservation sensor that a reservation is not available at a present time.

8. The computer executable method of claim 7, further comprising:
in response to the identification signal associated with the user not being known by the analysis server, providing an unknown indication on the reservation sensor.

9. The computer executable method of claim 7, wherein the identification signal is a biometric signal of the user.

10. The computer executable method of claim 7, wherein the positive indication comprises a countdown timer that indicates when the reservation will expire.

11. The computer executable method of claim 7, wherein the positive indication comprises at least one of:
a color display;
a display of information;
a sound; and
a movement.

12. The computer executable method of claim 7, wherein the identification signal is provided by an portable electronic device and the electronic device comprises an application which interfaces with the reservation sensor and the analysis server.

13. The computer executable method of claim 7, wherein the identification signal is a token that represents the user.

14. The computer executable method of claim 13, wherein the token is generated by a token application on a portable computing device and the token is communicated to a token server in communication with the analysis server.

15. The computer executable method of claim 7, wherein the identification signal comprises at least one of:
a packet of data;
a token; and
a unique rf signal.

16. The computer executable method of claim 7, further comprising displaying on the reservation sensor at least one of:
a countdown timer indicating time left on the reservation;
an indication that the user is not recognized;
an indication that a reservation is not currently available for the user; and
an indication of a ranking of the user in the reservation system.

17. The computer executable method of claim 7, wherein the identification signal is provided by an portable electronic device and the portable electronic device comprises a computing element that is charged by the sensor.

18. The computer executable method of claim 7, further comprising a threshold creation method to determine the threshold comprising:
determining current demand;
adjusting threshold based on current demand to create an adjusted threshold;
analyzing past scores of the user to create an updated score;
comparing the updated score to adjusted threshold; and
classifying the updated score in view of the adjusted threshold.

19. The computer executable method of claim 18, wherein the adjusted threshold is determined using a learning algorithm to:
review past threshold adjustments;
review past sales;
determine the optimal threshold adjustment to maximize sales; and
setting the adjusted threshold according to the determined optimal threshold adjustment.

20. The computer executable method of claim 7, wherein the reservation sensor further comprises a processor physically configured for:
receiving identification signals representative of a user;
communicating the identification signals representative of the user to the analysis server for a reservation response comprising a reservation approval, a reservation denial or a reservation pending;
receiving the reservation approval or reservation denial indication from the analysis server;
in response to receiving the reservation approval, executing at least one of:
displaying an indication that the good or service is reserved;
displaying a name of the user;
displaying a timer that indicates how long the good or service is reserved;
communicating an acceptance message to the portable computing device of the user;
communicating a timer to the portable computing device of the user;
creating a sound to indicate that the good or service has been reserved; and
creating a motion that indicate that the good or service has been reserved.
